(19) United States
(12) Patent Application Publication
(10) Pub. No.: US 2016/0221486 A1
(43) Pub. Date: Aug. 4, 2016

(54) APPARATUS FOR ACCOMMODATING BEVERAGE FOR VEHICLE

(71) Applicant: LG Innotek Co., Ltd., Seoul (KR)

(72) Inventors: Boone Won, Seoul (KR); Young Kil Song, Seoul (KR); Jong Bae Shin, Seoul (KR); Yong Sang Cho, Seoul (KR)

(21) Appl. No.: 15/013,516

(22) Filed: Feb. 2, 2016

(30) Foreign Application Priority Data
Feb. 2, 2015 (KR) 10-2015-0015972

(51) Int. Cl. B60N 3/10

(52) U.S. Cl. CPC B60N 3/104

(57) ABSTRACT

The embodiment of the present invention relates to equipment for accommodating a beverage for a vehicle capable of performing cooling and heating operations and an apparatus for accommodating a beverage for a vehicle which provides a cup holder for a vehicle having an improved structure capable of being detachably attached to places at a cup holder provided in the vehicle so that the convenience of use can be improved, and at the same time may combine frames having various sizes to change an insertion diameter of the cup holder to allow the apparatus to be easily mounted in a conventional cup holder for a vehicle so that the apparatus can be applied to various kinds of vehicles.

### CROSS-REFERENCE TO RELATED APPLICATION

This application claims the benefit under 35 U.S.C. §119 of Korean Patent Application No. 10-2015-0015972, filed Feb. 2, 2015, which is incorporated by reference in its entirety.

### BACKGROUND

1. Field of the Invention

The present invention relates to equipment for accommodating a beverage for a vehicle capable of performing cooling and heating operations.

2. Discussion of Related Art

Since a conventional cup holder for a vehicle serves to fix a cup so as to prevent contents in the cup from spilling into the vehicle due to movement of the vehicle, the conventional cup holder for a vehicle has a problem that the contents in the cup or a can cannot be cooled or heated and drunk. In order to solve this problem of the conventional cup holder for a vehicle, a cup holder capable of performing cooling and heating operations has been developed. However, in the conventional cup holder for a vehicle, a driver is unable to easily control a temperature inside the cup holder to various temperatures, and a cooling mode and a heating mode cannot be simultaneously executed.

Thus, a cup holder using a thermoelectric module for a vehicle has been developed. However, a conventional cup holder using a thermoelectric module for a vehicle has a built-in structure formed when the vehicle is manufactured, is not easily attached to or detached from the inside of the vehicle, and has to be adopted as an option when the vehicle is purchased. That is, only some models of vehicles introduce the cup holder using the thermoelectric module as an option, and thus usage is decreased.

In addition, even when this option is added to the vehicle, the conventional external cup holder using a thermoelectric module for a vehicle is bulky, and thus has a problem in that it requires a large space when the cup holder is being used in the vehicle and has a safety problem that the cup holder may fall over.

### BRIEF SUMMARY

The present invention is directed to an apparatus for accommodating a beverage for a vehicle capable of providing a cup holder for a vehicle having an improved structure capable of being detachably attached to places at a cup holder provided in the vehicle so that the convenience of use can be improved, and at the same time may combine frames having various sizes to change an insertion diameter of the cup holder to allow the apparatus to be easily mounted in a conventional cup holder for a vehicle so that the apparatus is capable of being applied to various kinds of vehicles.

According to an aspect of the present invention, there is provided an apparatus for accommodating a beverage for a vehicle, the apparatus includes: a first housing including a container accommodation portion and accommodating a thermoelectric module that applies a thermal conversion effect to an outer circumferential surface of the container accommodation portion; and a second housing coupled to a lower portion of the first housing and having a second diameter smaller than a first diameter of the first housing. The first housing may include a plurality of second housing coupling grooves formed in a bottom surface of the first housing and corresponding to a diameter of the second housing.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a front view of an apparatus for accommodating a beverage for a vehicle according to an embodiment of the present invention, FIG. 2 is a cross-sectional view taken along line of FIG. 1, and FIG. 3 is a view illustrating a general structure of a thermoelectric module according to the embodiment of the present invention described above in the structure of FIG. 2; and

FIGS. 4A through 4C and FIGS. 5A through 5D are conceptual views for explaining structures of thermoelectric modules according to other embodiments of the present invention.

### DETAILED DESCRIPTION OF EXEMPLARY EMBODIMENTS

A configuration and an operation according to the present invention will be described in detail below with reference to the accompanying drawings. Like reference numerals are used for like elements regardless of reference numerals of the drawings, and a redundant description thereof will be omitted. It should be understood that although the terms “first”, “second”, etc. may be used herein to describe various components, these components should not be limited by these terms. These components are only used to distinguish one component from another.

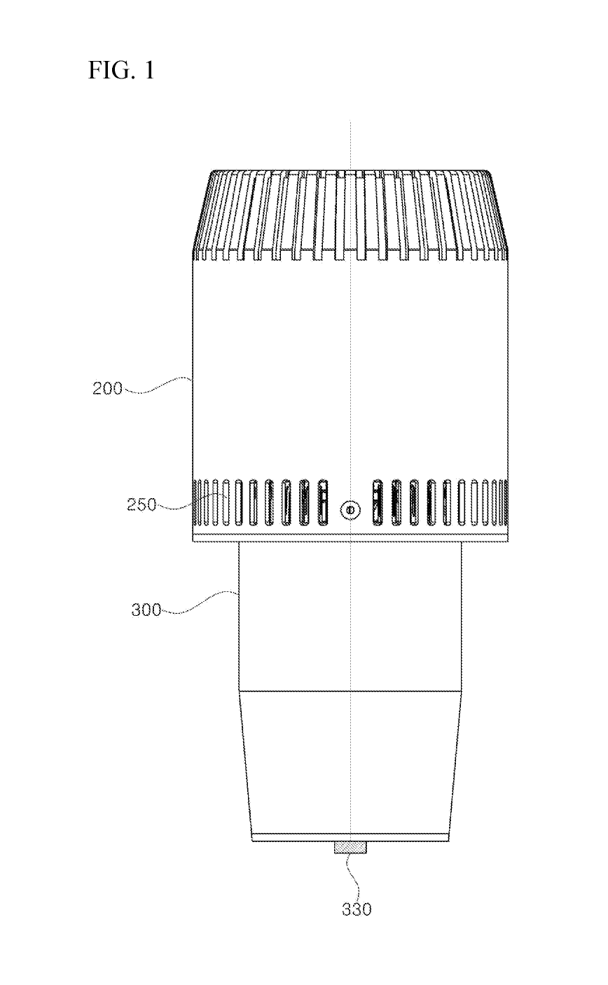

FIG. 1 is a front view of an apparatus for accommodating a beverage for a vehicle according to an embodiment of the present invention, and FIG. 2 is a cross-sectional view taken along line of FIG. 1.

Referring to FIGS. 1 and 2, the apparatus for accommodating a beverage for a vehicle according to the embodiment of the present invention includes a container accommodation portion 210, a first housing 200 that accommodates a thermoelectric module 100 for applying a thermal conversion effect to an outer circumferential surface of the container accommodation portion 210, and a second housing 300 that is coupled to a lower portion of the first housing 200 and has a second diameter B smaller than a first diameter A of the first housing 200. The first housing 200 may include a plurality of second housing coupling grooves 240 that are formed in a bottom surface of the first housing 200 and correspond to a diameter of the second housing 300. Thus, the entire exterior of the apparatus for accommodating the beverage for the vehicle according to the embodiment of the present invention is formed in such a way that the first housing 200 and the second housing 300 are coupled to each other in a vertical direction, and a container (a cup) for storing a beverage is inserted into an upper portion of the first housing 200, and a lower portion of the second housing 300 is easily inserted into mounting grooves (holes of a conventional cup holder) provided in the vehicle. Because various designs and sizes may be selected according to the diameter of the second housing 300 so that the second housing 300 is coupled to the first housing 200, an attachable beverage accommodation container capable of controlling temperature can be widely used.

In detail, referring to FIGS. 1 and 2, an outer circumferential surface of the first housing 200 may be implemented in a cylindrical shape, like in a structure illustrated in FIGS. 1 and 2, and the first housing 200 may include the container accommodation portion 210. The exterior of the first housing 200 may be modified in various shapes including the cylindrical shape. The container accommodation portion 210 is implemented in a shape of a concave groove, like in the structure illustrated in FIG. 2, and has an open upper portion. In addition, upper and lower portions of the beverage accommodation portion 210 have a uniform diameter C. However, embodiments of the present invention are not limited thereto, and a width of the upper portion of the container accommodation portion 210 may be larger than a width of the lower portion of the container accommodation portion 210 so that the container accommodation portion 210 is mounted in various ways according to the design of a cup. In addition, the apparatus for accommodating a beverage for a vehicle may be formed to have a separable structure so that the shape of the container accommodation portion 210 accommodated in the first housing 200 is modified in various ways.

The container accommodation portion 210 has a hollow structure, like in the structure of FIG. 2, and may be formed of a metal material having high thermal conductivity or a conductive resin material. In particular, a bottom surface of the container accommodation portion 210 may be formed adjacent to a heating portion or a heat absorption portion of the thermoelectric module 100, which will be described later, so that a thermal conversion effect is directly transferred to the container accommodation portion 210. In one example, the bottom surface of the container accommodation portion 210 may be formed in direct contact with a substrate surface of the heating portion or the heat absorption portion of the thermoelectric module 100. That is, even when the shape of the outer circumferential surface of the container accommodation portion 210 is modified in various ways, the bottom surface of the container accommodation portion 210 may be formed so that heat is transferred to the bottom surface of the container accommodation portion 210. To this end, the container accommodation portion 210 and an accommodation portion 201 of the first housing 200 may be implemented to have diameters that do not exactly correspond to each other, but are spaced apart from each other to a certain extent.

In addition, the apparatus for accommodating a beverage for a vehicle according to the embodiment of the present invention may further include a circulation control module 230 that is accommodated in the first housing 200 and controls thermoelectric efficiency by injecting outside air into a heating surface or a heat absorption surface of the thermoelectric module 100. The circulation control module 230 is implemented to control a rise and a fall of temperature generated in the heating portion or the heat absorption portion of the thermoelectric module 100 by applying a flow of air into an inner space of the first housing 200 so that thermoelectric efficiency is improved. That is, the thermoelectric module 100 having a uniform thermoelectric efficiency ΔT applies cold air that serves to decrease the temperature of the heating portion so as to maintain a uniform temperature to further decrease the temperature of the heat absorption portion so that cooling efficiency is improved or heating efficiency is improved while working in the opposite way. To this end, the circulation control module 230 according to the present invention may include a fan unit 231 that allows the flow of air and a control module for controlling an amount of air-flow or temperature of the fan unit 231.

In addition, the second housing 300 may be implemented to have a structure coupled to the bottom surface of the first housing 200 and to have a shape of a cylindrical circumference through which the second housing 300 is inserted into an insertion hole of a conventional cup holder for a vehicle. In this case, the second housing 300 may be implemented to have a diameter that tapers toward the lower portion of the second housing 300 and to be easily inserted into insertion holes having various sizes. In particular, a diameter of the upper portion of the second housing 300 according to the embodiment of the present invention may be equal to or less than a diameter of the lower portion of the first housing 200. In particular, a plurality of second housing coupling grooves 240 that correspond to a width (a diameter) of the upper portion of the second housing 300 are provided in the bottom surface of the first housing 200 so that second housings 300 having various sizes may be coupled to the first housing 200.

In addition, the second housing 300 further includes a switching member 330 having a structure of a dome switch that protrudes from a bottom surface of the second housing 300. The switching member 330 is configured to be electrically connected to a printed circuit board (PCB) 330 including a control circuit of the thermoelectric module 100 embedded in the second housing 300, and when the second housing 300 is mounted in the apparatus for accommodating a beverage for a vehicle, the switching member 330 is naturally pressed so that the thermoelectric module 100 may be operated. In addition, the PCB 330 is mounted on a mounting portion 310 mounted in the second housing 300 so that spatial utility is improved. In this case, like in the structure of FIG. 2 that is not a general horizontal arrangement, the mounting portion 310 may be mounted to be perpendicular to the bottom surface of the second housing 300, or the second housing 300 may be formed to be inclined having a uniform inclination. When the second housing 300 is implemented in an inclined arrangement structure, the height of the second housing 300 is further reduced so that the size of the entire equipment can be remarkably reduced.

In addition, the first housing 200 according to the embodiment of the present invention includes a communication hole 250 that communicates with an inner space of the first housing 200 to allow circulation of air so that thermoelectric efficiency is improved.

Furthermore, in the structure of FIG. 2, the container accommodation portion 210 may be implemented using a material having high thermal conductivity so that heat is easily transferred to the container accommodation portion 210 by accumulating cold air and warm air, and may serve as a kind of heat sink. The container accommodation portion 210 and the above-described circulation control module 230 may be implemented as a detachable structure.

FIG. 3 is a view illustrating a general structure of the thermoelectric module 100 according to the embodiment of the present invention described above in the structure of FIG. 2.

The thermoelectric module 100 including a thermoelectric semiconductor element (hereinafter, referred to as a ‘thermoelectric element’) according to the embodiment of the present invention may be formed to have a structure including at least one unit cell including a first substrate 140 and a second substrate 150 that face each other, a first semiconductor element 120 disposed between the first substrate 140 and the second substrate 150, and a second semiconductor element 130 disposed between the first substrate 140 and the second substrate 150 and electrically connected to the first semiconductor element 120. In this case, in a thermoelectric module for cooling, the first substrate 140 and the second substrate 150 may be ordinary insulating substrates, for example, alumina substrates. Alternatively, in the embodiment of the present invention, heat dissipation efficiency and small thickness may be implemented using metal substrates. In the structure of FIG. 2, the first substrate 140, the second substrate 150, and the container accommodation portion 210 may be disposed so that their surfaces are in contact with each other.

In addition, when the above-described first substrate 140 and the second substrate 150 are formed using metal substrates, as illustrated in FIG. 3, dielectric layers 170a and 170b may be further formed between electrode layers 160a and 160b formed on the first substrate 140 and the second substrate 150, respectively. Copper (Cu) or a Cu alloy may be used for the metal substrates, and the metal substrates may be formed at a small thickness of 0.1 mm to 0.5 mm. In this case, when the thickness of the metal substrate is smaller than 0.1 mm or exceeds 0.5 mm, a heat dissipation characteristic is excessively high or thermal conductivity is very high and that causes the reliability of the thermoelectric module 100 to be greatly lowered.

In addition, the dielectric layers 170a and 170b may be formed using dielectric materials having high heat dissipation performance, i.e., materials having a thickness of 0.01 mm to 0.15 mm and a thermal conductivity of 5 to 10 W/K in consideration of a thermal conductivity of the thermoelectric module for cooling. In this case, when the thickness of each of the dielectric layers 170a and 170b is less than 0.01 mm, insulating efficiency (or withstand voltage characteristic) is greatly lowered, and when the thickness of each of the dielectric layers 170a and 170b exceeds 0.15 mm, thermal conductivity is lowered so that heat dissipation efficiency is lowered.

The electrode layers 160a and 160b electrically connect the first semiconductor element 120 and the second semiconductor element 130 using electrode materials, such as Cu, silver (Ag), and nickel (Ni). A thickness of each of the electrode layers 160a and 160b may be in the range of 0.01 mm to 0.3 mm. When the thickness of each of the electrode layers 160a and 160b is less than 0.01 mm, functions as electrodes are lowered, and thus electric conductivity is lowered, and even when the thickness of each of the electrode layers 160a and 160b exceeds 0.3 mm, conductivity efficiency is lowered due to an increase in resistance.

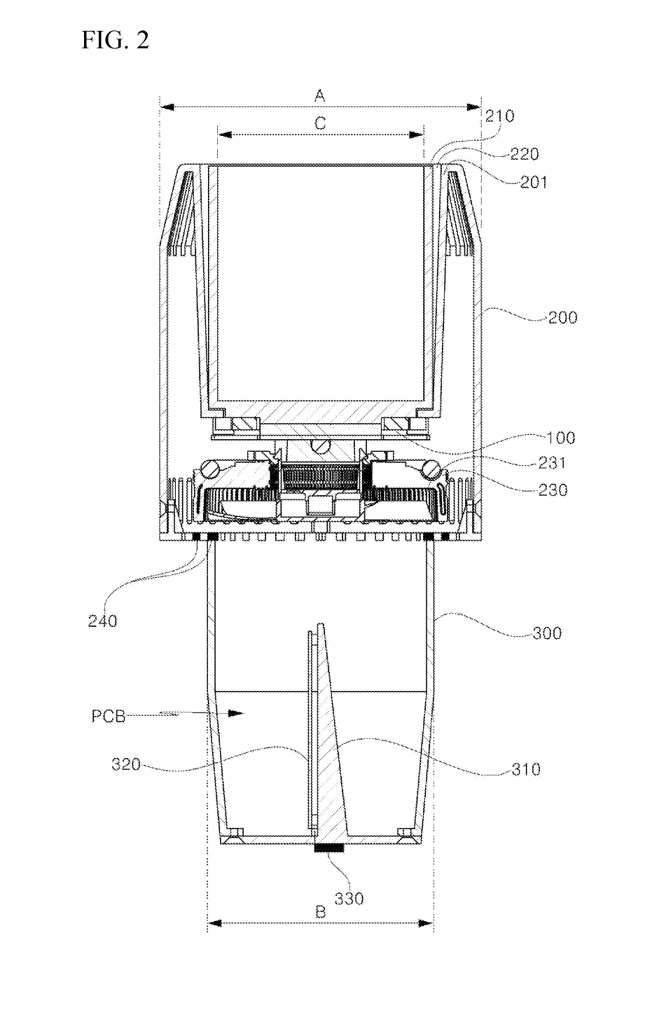

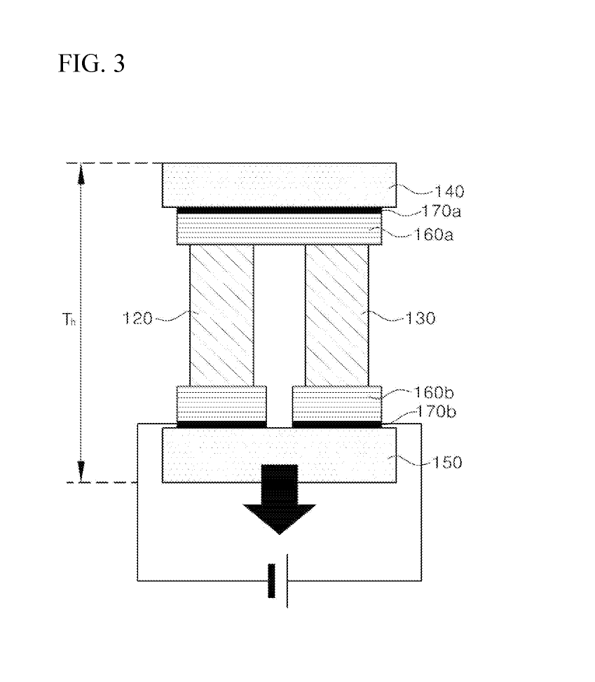

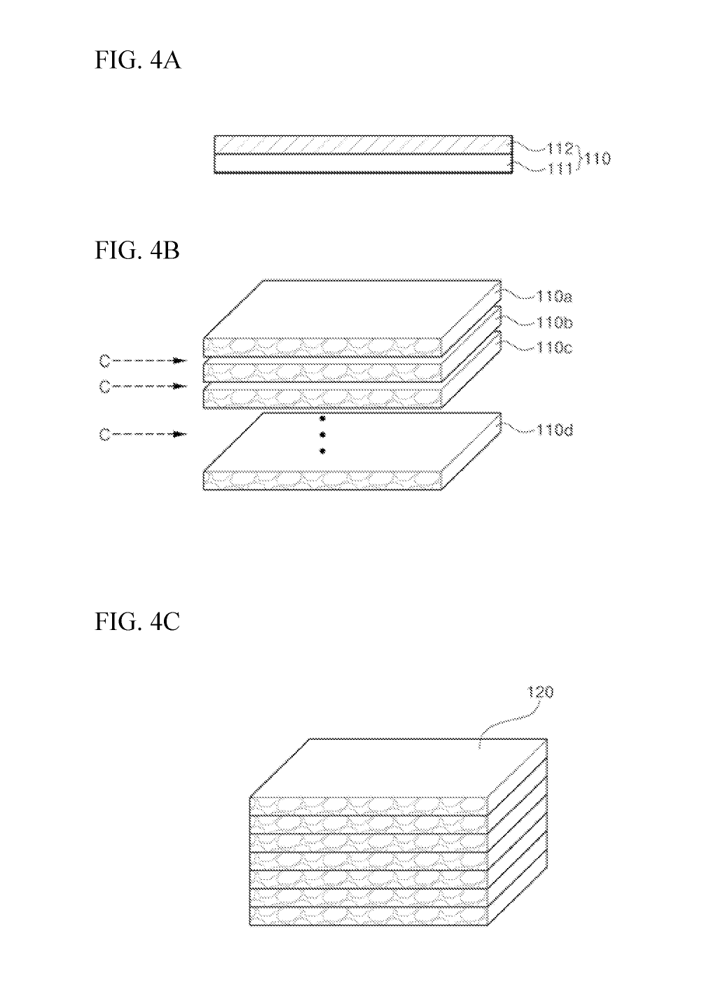

In the thermoelectric module 100 according to the embodiment of the present invention, when the thermoelectric element having the structure of FIG. 3 is formed to have a stacked sheet type structure, as will be illustrated in FIG. 4, it may be implemented with a slimmer structure so that a beverage storing container is made slimmer. Referring to FIGS. 4A through 4C, basically, a unit thermoelectric element according to the embodiment of the present invention may be implemented with a structure having a multi-layer stack, unlike in a bulky manufacturing process. In a process of manufacturing the unit thermoelectric element, a material including a material formed of a semiconductor material is manufactured in a form of a paste, and the paste is applied onto a base material 111, such as a sheet or a film, so as to form a semiconductor layer 112 and to form one unit member 110. In the unit member 110, a plurality of unit members 100a, 100b, and 100c are stacked to form a stacked structure, as illustrated in FIG. 2, and subsequently, the stacked structure is cut to form a unit element 120. That is, the unit element 120 according to the present invention may be formed as a structure in which a plurality of unit members 110 formed by stacking semiconductor layers 112 on the base material 111 are stacked.

A process of applying a semiconductor paste onto the base material 111 of the above-described process may be implemented using various methods. In one example, the process may be implemented using tape casting, i.e., a method, whereby a slurry is manufactured by mixing a very fine semiconductor material powder with one selected from the group consisting of an aqueous or non-aqueous solvent, a binder, a plasticizer, a dispersant, a defoamer, and a surfactant, and then the slurry is formed on a moving blade or a moving transportation base material to a uniform thickness according to a purpose. In this case, the thickness of the base material may be the thickness of a material, such as a film or a sheet, in the range of 10 um to 100 um, and the applied semiconductor material may be a P-type semiconductor material or an N-type semiconductor material. The N-type semiconductor material may be formed using a mixture of a bismuth telluride (BiTe)-based main raw material including selenium (Se), nickel (Ni), aluminum (Al), copper (Cu), silver (Ag), lead (Pb), boron (B), gallium (Ga), tellurium (Te), bismuth (Bi), or indium (In), and Bi or Te that is used in an amount of 0.001 to 1.0 parts by weight, based on 100 parts by weight of the main raw material. For example, the N-type semiconductor material may be formed using a mixture of a Bi—Se—Te material as the main raw material and Bi or Te that is used in an amount of 0.001 to 1.0 parts by weight, based on 100 parts by weight of Bi—Se—Te. That is, when 100 g of Bi—Se—Te is added to the main raw material, Bi or Te to be additionally mixed may be in the range of 0.001 to 1.0 g. As described above, the weight range of a material to be added to the main raw material has meaning in that, when the material is out of the range of 0.001 to 1.0 parts by weight, based on 100 parts by weight of the material, thermal conductivity is not lowered and electric conductivity is lowered and improvements in a ZT value cannot be expected.

The P-type semiconductor material may be formed using a mixture of a BiTe-based main raw material including antimony (Sb), nickel (Ni), aluminum (Al), copper (Cu), silver (Ag), lead (Pb), boron (B), gallium (Ga), tellurium (Te), bismuth (Bi), or indium (In), and Bi or Te that is used in an amount of 0.001 to 1.0 parts by weight, based on 100 parts by weight of the main raw material. For example, the P-type semiconductor material may be formed using a mixture of a Bi—Sb—Te as the main raw material and Bi or Te that is used in an amount of 0.001 to 1.0 parts by weight, based on 100 parts by weight of Bi—Sb—Te. That is, when the weight of Bi—Sb—Te is added to the main raw material, Bi or Te to be additionally mixed may be in the range of 0.001 to 1.0 g. The weight range of the above-described material to be added to the main raw material has meaning in that, when the material is out of the range of 0.001 to 1.0 parts by weight, based on 100 parts by weight of the material, thermal conductivity is not lowered and electric conductivity is lowered and improvements in a ZT value cannot be expected.

In addition, in a process of aligning the unit members 110 in a multi-layer shape and stacking the unit members 110, the unit members 110 may be pressed at a temperature of 50° C. to 250° C. and may be formed in a stacked structure. In the embodiment of the present invention, the number of stacks of the unit members 110 may be in the range of 2 to 50. Subsequently, a cutting process may be performed in a desired shape and size, and a sintering process may be added.

The unit element 120 formed by stacking a plurality of unit members 110 manufactured in the above-described process may obtain a uniformity of thickness, shape, and size. That is, in a conventional bulky thermoelectric module, after ingot grinding and refining ball-mill process are performed, a sintered bulk structure is cut. Thus, it should be obvious that there are many materials damaged in the cutting process, and it is difficult to cut the conventional bulky thermoelectric module to a uniform thickness. In addition, the conventional bulky thermoelectric module has a large thickness of about 3 mm to 5 mm, and thus it is difficult to make a slim thermoelectric module. However, in the unit element 120 having the stacked structure according to the embodiment of the present invention, after sheet-shaped unit members are stacked in a multi-layer structure, a sheet stacked structure is cut. Thus, there is hardly any loss of a material, and the material has a uniform thickness. Thus, uniformity of the material can be obtained, the thickness of the entire unit element is equal to or less than 1.5 mm, and the entire unit element is able to be made slim and may be applied in various shapes.

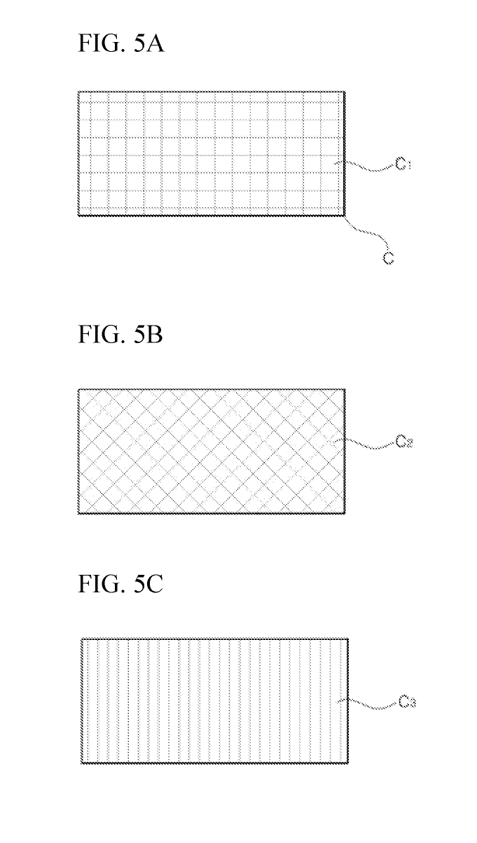

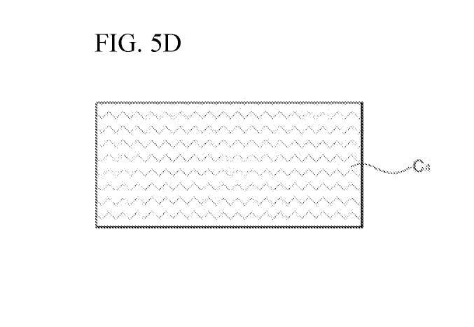

In particular, the process of manufacturing the unit element according to the embodiment of the present invention may be implemented by additionally performing a process of forming a conductive layer on a surface of each unit member 110 while a process of forming a stacked layer of the unit member 110 is performed. That is, the conductive layer having the structure of FIG. 5 may be formed between unit members of the stacked structure of FIG. 4C. The conductive layer may be formed on an opposite surface to a base material surface on which a semiconductor layer is formed. In this case, the conductive layer may be configured as a patterned layer so that a region in which a surface of the unit member is exposed is formed. Thus, electric conductivity can be improved when compared with a case where the conductive layer is formed on the entire surface of the unit member, and adhesion between unit members can be improved, and at the same time thermal conductivity can be lowered.

That is, FIGS. 5A through 5D illustrate various modified examples of a conductive layer C according to other embodiments of the present invention. Patterns through which the surface of the unit member is exposed may be modified in various shapes including a mesh type structure including closed aperture patterns C₁ and C₂, as illustrated in FIGS. 5A and 5B, or a line type structure including open aperture patterns C₃ and C₄, as illustrated in FIGS. 5C and 5D. The above conductive layers allow adhesion between unit members inside a unit element formed to have a stacked structure of unit members to be improved, thermal conductivity between unit members to be lowered, and electric conductivity to be improved. In addition, a cooling capacity Qc and ΔT(° C.) are improved when compared with the conventional bulky thermoelectric element, and in particular, a power factor is improved by 1.5 times, i.e., electric conductivity is improved by 1.5 times. Improvements in electric conductivity are directly connected to improvements in thermoelectric efficiency so that cooling efficiency is increased.

The conductive layer may be formed of a metal material, and all electrode materials based on metals, such as Cu, Ag, and Ni, may be used to form the conductive layer.

When the thermoelectric element having the structure of FIGS. 4A through 4C or FIGS. 5A through 5D is applied to the apparatus for accommodating a beverage for a vehicle according to an embodiment of the present invention, thermoelectric efficiency can be improved, and at the same time a degree of freedom of design in which the size of the entire apparatus can be easily reduced or increased to a desired size can be obtained.

The apparatus for accommodating a beverage for a vehicle according to the embodiment of the present invention can be driven in the following way.

First, referring to FIGS. 1 and 2, a user inserts a beverage container into the first housing 200 of the apparatus for accommodating a beverage for a vehicle. As described above, the container accommodation portion 210 for storing the beverage is disposed in the first housing 200, and a beverage container, such as a can or a cup, can be inserted into the container accommodation portion 210.

Next, a pressing force applied when the beverage container is inserted into the container accommodation portion 210 is transferred to the first housing 200, and an external force is applied to one surface of the first housing 200 and presses the above-described switching member 330. Due to the pressed switching member 330, the circulation control module 230 applies power to the above-described thermoelectric module. When power is applied to the thermoelectric module, the power is used to operate the thermoelectric semiconductor coupled to the apparatus for accommodating a beverage for a vehicle, and a heating source or a cooling source generated in the thermoelectric semiconductor is transferred to the first housing 200. Furthermore, the heating source or the cooling source transferred to the first housing 200 is transferred to the beverage container. Thus, a thermal conversion effect that heats or cools the beverage container can be realized.

In addition, when power is applied to the thermoelectric module due to the pressed switching member 330, the circulation control module 230 operates so that the fan unit 231 operates simultaneously. The fan unit 231 allows the flow of inside air and further increases heat transfer efficiency. In particular, when the cooling source is transferred to the beverage container, an operation effect in which cooling efficiency can be supplemented, is increased. Alternatively, the amount of air-flow of the fan unit 231 or a temperature of wind can be controlled by driving the circulation control module 230 so that the effect of cooling or heating can be realized.

As described above, according to an embodiment of the present invention, an apparatus for accommodating a beverage for a vehicle provides a cup holder for a vehicle having an improved structure capable of being detachably attached to places at a cup holder provided in the vehicle so that the convenience of use can be improved, and at the same time may combine frames having various sizes to change an insertion diameter of the cup holder to allow the apparatus to be easily mounted in a conventional cup holder for a vehicle so that the apparatus can be applied to various kinds of vehicles.

In addition, according to an embodiment of the present invention, a thermoelectric module for heating a container accommodation portion or absorbing heat from the container accommodation portion is implemented to have a sheet type stacked structure so that thermal conductivity can be lowered, electrical conductivity can be improved, a cooling capacity Qc and a temperature change rate ΔT can be remarkably improved, and a cup holder having a slimmer structure can be implemented, and thus spatial efficiency can be improved.

Specifically, a conductive pattern layer is included between unit members having a stacked structure so that electrical conductivity can be maximized, and the thickness of a thermoelectric module according to the embodiment of the present invention is remarkably reduced when compared with the thickness of a conventional bulky thermoelectric module so that spatial utility can be maximized.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An apparatus for accommodating a beverage for a vehicle, the apparatus comprising:
a first housing comprising a container accommodation portion and a thermoelectric module that applies a thermal conversion effect to an outer circumferential surface of the container accommodation portion; and
a second housing coupled to a lower portion of the first housing and having a second diameter smaller than a first diameter of the first housing.

2. The apparatus of claim 1, wherein the first housing comprises a plurality of second housing coupling grooves formed in a bottom surface of the first housing and corresponding to a diameter of the second housing.

3. The apparatus of claim 1, further comprising a circulation control module accommodated in the first housing and controlling thermoelectric efficiency by injecting outside air into a heating surface or a heat absorption surface of the thermoelectric module.

4. The apparatus of claim 3, wherein the circulation control module comprises a fan unit.

5. The apparatus of claim 3, further comprising a printed circuit board comprising a control circuit accommodated in the second housing and controlling a driving of the thermoelectric module or the circulation control module.

6. The apparatus of claim 5, further comprising a switching member electrically connected to the printed circuit board and protruding from a bottom surface of the second housing.

7. The apparatus of claim 6, wherein the first housing comprises a communication hole that communicates with an inner space of the first housing.

8. The apparatus of claim 5, further comprising a mounting portion for mounting the printed circuit board extending in an upward direction from a bottom surface of the second housing.

9. The apparatus of claim 8, wherein the mounting portion forms an incline with the bottom surface of the second housing.

10. The apparatus of claim 1, wherein the thermoelectric module comprises a unit thermoelectric element having a stacked structure of two or more unit members, which have thermoelectric semiconductor layers disposed on base materials thereof.

11. The apparatus of claim 10, wherein the unit thermoelectric element further comprises a conductive layer between adjacent unit members.

12. The apparatus of claim 11, wherein the conductive layer has a patterned structure in which a surface of the base material is exposed.

13. The apparatus of claim 1, wherein at least one of a first substrate and a second substrate of the thermoelectric element contacts with a surface of the container accommodation portion.

14. A method of driving an apparatus for accommodating a beverage for a vehicle comprising a first housing comprising a container accommodation portion and a thermoelectric module that applies a thermal conversion effect to an outer circumferential surface of the container accommodation portion and a second housing coupled to a lower portion of the first housing and having a second diameter smaller than a first diameter of the first housing, the method comprising:
inserting a beverage container into the container accommodation portion of the apparatus for accommodating a beverage for a vehicle;
pressing a switching portion using an external force applied to one surface of the first housing;
driving the thermoelectric module using a circulation control module disposed in the first housing according to an operation of the switching portion; and
transferring a thermal conversion effect caused by the driving of the thermoelectric module to the first housing.

15. The method of claim 14, wherein the transferring of the thermal conversion effect caused by the driving of the thermoelectric module to the first housing comprises:
driving a fan unit using the circulation control module; and
applying cold air or warm air to a heating surface or a heat absorption surface of the thermoelectric module using the fan unit.
